(19) United States
(12) Patent Application Publication
(10) Pub. No.: US 2007/0247541 A1
(43) Pub. Date: Oct. 25, 2007

(54) Image recording device for connection to an observation device and observation device having an image recording device of this type

(76) Inventors: Erhardt Mutz, Waldsolms (DE); Volker Tautz, Wetzlar (DE); Armin Schlierbach, Leun (DE); Norbert Mueller, Asslar (DE)

Correspondence Address: HARNESS, DICKEY & PIERCE, P.L.C., P.O. BOX 828, BLOOMFIELD HILLS, MI, 48303, US

(21) Appl. No.: 11/715,745

(22) Filed: Mar. 8, 2007

(30) Foreign Application Priority Data
Mar. 9, 2006 (DE) 20 2006 004 094.3

(51) Int. Cl. H04N 5/225

(52) U.S. Cl. 348/341

(57) ABSTRACT

An image recording device for eyepiece-side connection to an observation device, in particular to a monocular observation device, which provides an object image of an object to be observed, comprises an image recorder unit for recording the object image, and an eyepiece unit. The image recording device further comprises, on the input side, a beam splitter for splitting a light beam incident in the image recording device into a first light beam directed towards the image recorder unit and a second light beam directed towards the eyepiece unit for observing the object image through the eyepiece unit.

### CROSS REFERENCE TO RELATED APPLICATION

The present application claims priority of German utility model application No. 20 2006 004 094.3 filed on Mar. 9, 2006.

### BACKGROUND OF THE INVENTION

The invention relates to an image recording device for connection to an observation device, in particular to a monocular observation device, which provides an object image of an object to be observed, wherein the image recording device comprises an image recorder unit for recording the object image.

The invention furthermore relates to an observation device having an image recording device of this type.

An image recording device for connection to an observation device is known from US 2004/0207750 A1, for example. The known image recording device comprises a digital image recorder unit arranged in a focal plane of an objective lens unit of a monocular observation device. The image recording device furthermore has an angle-adjustment unit for adjusting an angle of the image recording device in relation to the observation device, an image storage unit for storing an image recorded by the image recorder unit, and a display screen unit for displaying the image recorded by the image recorder unit. The image recording device is connected to the rear side, which faces away from the object, of the observation device, an eyepiece of the observation device, which is arranged on the latter as standard, having previously been removed.

An observation device in terms of the present invention is in particular a monocular observation telescope known under the name spotting scope. A spotting scope generally produces an erect and laterally correct image.

The observation device can, however, also be an astronomical telescope in the present case.

Typical areas of use of a spotting scope are field observations, in particular bird watching, sporting events, such as target observations, to name but a few examples. The spotting scope is ideally of compact design and has a short focal length, is relatively light-weight and robust, and protected against impacts and splashing water. A spotting scope is mostly used together with a stand. For practical observation, most models are provided with a 45° oblique viewing-in angle. Typical diameters of the objective unit are 65, 80, 85 and 100 mm having magnifications of from 20 to 80 times. A spotting scope is further equipped with interchangeable and zoom eyepieces. Different eyepieces are used in a spotting scope in order to match the magnification and the field of view to the respective application purpose. Spotting scopes are usually, in terms of design, refracting telescopes (refractors), less frequently reflecting telescopes (reflectors).

Conventional spotting scopes are usually designed for observation purposes, where the object cannot be photographed with the spotting scope. However, spotting scopes with an integrated image recording device, for example an integrated digital camera, are known.

Photographing the observed objects is possible with a conventional image recording device like the one mentioned above, which has an image recorder unit. The image recorder unit is typically a camera which can be connected directly to an eyepiece of the spotting scope via an adapter.

It is disadvantageous in an image recording device of this type that a cut-down image occurs, that is to say that, depending on the type of camera and adapter used for connecting the image recording device, it is impossible to record the entire image field. In addition, aligning the image recording device and the spotting scope with respect to one another is complicated.

It is furthermore a disadvantage that it is possible to observe the object only through the viewfinder of the image recorder unit or via the display screen unit.

### SUMMARY OF THE INVENTION

The object of the present invention is therefore to provide an image recording device which can be used to observe an object as if the observation instrument itself were used and to record an image.

According to an aspect of the present invention, an image recording device for eyepiece-side connection to an observation device providing an object image of an object to be observed is provided, comprising an image recorder unit for recording the object image, an eyepiece unit, and a beam splitter for splitting an incoming light beam into a first light beam directed towards the image recorder unit and a second light beam directed towards the eyepiece unit for observing the object image through the eyepiece unit.

According to another aspect of the invention, an observation device providing an object image of an object to be observed is provided, comprising an image recording device for recording the object image, the image recording device comprising an image recorder unit for recording the object image, an eyepiece unit, and a beam splitter for splitting a light beam into a first light beam directed towards the image recorder unit and a second light beam directed towards the eyepiece unit for observing the object image through the eyepiece unit.

The beam splitter produces two separate optical channels in the image recording device, to be precise an optical channel having the eyepiece unit (referred to as observation channel below) and an optical channel having the image recorder unit (referred to as recording channel below). An intermediate image upstream of the beam splitter, which is produced by an objective lens unit of the observation device and by an input-side lens of the image recording device which is preferably provided, is thus imaged via the two abovementioned optical channels onto the image recorder unit on the one hand and secondly onto the eyepiece unit on the other hand.

It is thereby advantageously possible to simultaneously observe and photograph in separate channels by means of the image recording device connected to the observation device.

It is thereby also advantageously possible to match the image size differently, that is to say to provide one magnification A₁ in the observation channel and a different magnification A₂ in the recording channel.

In a preferred refinement of the invention, a reticle is arranged between the beam splitter and the eyepiece unit such that a position of the reticle and a position of the image recorder unit are conjugated to one another.

This measure has the advantage that, if the object image is focussed on the reticle, it is also sharply focussed at the position of the image recorder unit. This means that the observer who observes the image of an object to be observed can sharply focus this image by means of focussing elements and a sharp image is automatically produced on the image recorder unit without the object image having to be additionally focussed on the image recorder unit.

An image detail of the object image is imaged onto the reticle. This achieves eye alignment. If the reticle can be seen sharply in the eyepiece, the object image imaged onto the image recorder unit is also sharp. A complicated alignment of the image recording device with respect to the observation device is no longer necessary.

In a further preferred refinement, at least one lens unit is arranged between the beam splitter and the reticle.

The at least one lens unit is used to image the object image produced by the objective unit of the observation device onto the reticle.

In a further preferred refinement of the invention, at least one diaphragm is arranged between the beam splitter and the reticle.

A diaphragm or a diaphragm system can be used to advantageously limit the light beam in order to match the latter to the size of the reticle and also of the image recorder unit or in order to regulate the brightness.

In a further preferred refinement, the eyepiece unit has associated with it a focussing device for manually focussing the object image observed through the eyepiece unit.

The focussing device can be used to sharply focus the object image imaged onto the abovementioned reticle, as is familiar to a user of a conventional spotting scope.

In a further preferred refinement of the invention, the image recorder unit has a photosensitive element, preferably an electronic imager.

The electronic imager can, in particular, be a CCD (charged coupled device) chip or a CMOS chip with high resolution. The digital photo camera of this design can record the object image and store it. A possible connection to media, in particular computers for further processing the digitally stored image, can easily be provided, for example by means of a USB port.

In a further preferred refinement, at least one lens unit for imaging the object image onto the image recorder unit is arranged between the beam splitter and the image recorder unit.

The lens unit advantageously achieves a magnification of the intermediate image corresponding to the size of the image recorder unit. The magnification of the object image imaged onto the image recorder unit can here be different from a magnification of the object image seen by the observer through the eyepiece unit.

In a further preferred refinement of the invention, at least one diaphragm is arranged between the beam splitter and the image recorder unit.

The diaphragm can be used to set the exposure time of the image recorder.

In a further preferred refinement of the invention, the image recording device has a connection unit which enables connection of the image recording device to the observation device.

In this case, the connection unit can be a bayonet connection or an external/internal thread structure. Preferably a standardized connection unit is provided, so that no made-to-order intermediate adapters are necessary for enabling connection of the image recording device to the observation device.

In a further preferred refinement, the eyepiece unit is interchangeable.

It is an advantage here that the image recorder device according to the invention can be used with different eyepieces which enable, for example, a different magnification of the object image observed through the eyepiece unit, as is familiar to the user of a conventional spotting scope.

In a further preferred refinement of the invention, a remote control, preferably a cordless remote control is provided for triggering the image recorder unit.

This enables a shake-free triggering of the camera. The cordless remote control used can be, for example, an infrared remote control.

An observation device already available to a user, for example a standard spotting scope, can advantageously be fitted with the image recording device according to the invention, so that simultaneous observation and photographing of objects by means of two separate optical channels is possible. In this context, the observation of the object is enabled by the observation channel and the recording and photographing by means of the recording channel.

Advantageously, the observation is no longer performed, as in the case of a spotting scope having an image recorder unit from the prior art, through the camera viewfinder, but through an eyepiece having significantly improved optical characteristics and with the possibility of manual focussing.

Further advantages and features result from the following description and the attached drawing.

It is evident that the abovementioned features and the features which are still to be explained below can be used not only in the respectively stated combination, but also in other combinations or alone without departing from the scope of the present invention.

### BRIEF DESCRIPTION OF THE DRAWINGS

The present invention is explained in further detail below with reference to a selected exemplary embodiment.

FIG. 1 shows an observation device with connected image recording device;

FIG. 2 shows the image recording device in FIG. 1 in a longitudinal section; and

FIG. 3 shows a schematic illustration of the beam path of the image recording device in FIG. 2.

### DETAILED DESCRIPTION OF A PREFERRED EMBODIMENT

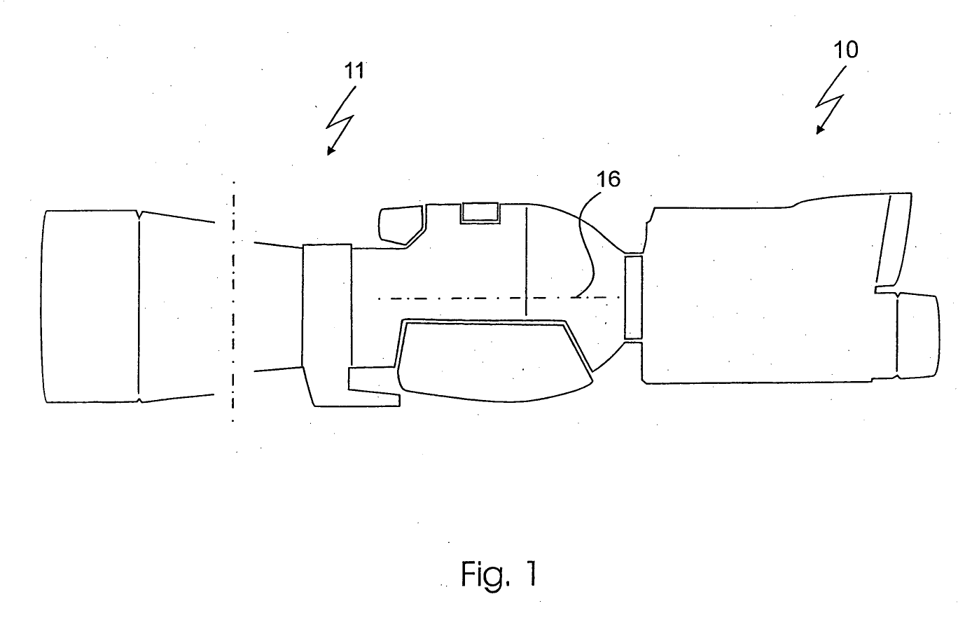

FIG. 1 through 3 show an image recording device 10 according to the invention, which is, in FIG. 1, connected to an observation device 11 by means of a connection unit 12. The image recording device 10 can be removed from the observation device 11. The illustrated observation device 11 is a monocular spotting scope. The image recording device 10 can also be connected to a telescope, for example, rather than a spotting scope.

The image recording device 10 has, on the input side, a beam splitter 14 which is in the form of a splitter prism. A light beam propagating along an optical axis 16 of the observation device 11 is split by the beam splitter into a first light beam directed further along a first optical axis 18 of the image recording device 10 and into a second light beam directed along a second optical axis 20 of the image recording device 10. An optical observation channel 22 is provided along the second optical axis 20 and an optical recording channel 24 is provided along the first optical axis 18.

The observation channel 22 has an eyepiece unit 26, a reticle 28 and also a first lens unit 30 and a second lens unit 32. Furthermore, a diaphragm 33′ is arranged in the observation channel 22. It is, however, also possible within the scope of the invention to provide a number of diaphragms in the observation channel 22.

The recording channel 24 has an image recorder unit 34 having an electronic imager 35. The photosensitive imager 35 is, for example, a CCD chip or a CMOS chip. It is, however, also possible to use analog photosensitive elements, such as a silver halide film.

A diaphragm 33 is furthermore arranged in the recording channel 24.

The recording channel 24 has furthermore a first lens unit 36 and a second lens unit 38.

The image recording device 10 has furthermore a display screen unit 40 for displaying the recorded object image.

The observation channel 22, the recording channel 24 and also the display screen unit 40 are arranged in a housing 42 of the image recording device 10, at whose one end the connection unit 12 is arranged, so that the housing 42 of the image recording device 10 can be connected to a housing of the observation device 11, as illustrated in FIG. 1. The image recording device 10 can furthermore also have an image storage unit (not illustrated in more detail here) for storing the image recorded with the image recorder unit 34.

The mode of operation of the image recording device 10 is described below.

The arrangement of observation device 11 and image recording device 10 according to FIG. 1 can be used, for example, for field observations, for example bird watching, or also for sport-related observations. The eyepiece unit 26 can be used to observe an object imaged by the objective of the observation device 11 directly with the eye and in a magnified fashion.

The object image is sharply focussed here manually on the eyepiece unit 26 such that a sharp in-focus image of the object is produced on the reticle 28.

If the observer wishes to document this image by means of photography, he operates a remote control (not illustrated here), for example an infrared remote control, and thus triggers the digital image recorder unit 34. On account of the fact that the reticle 28 and the image recorder unit 34, to be more precise the imager 35, are arranged at mutually conjugate positions in the observation channel 22 and in the recording channel 24, the object image is sharp at the position of the image recorder unit 34 if it is sharp at the position of the reticle 28. It is not necessary to carry out a separate focussing operation in the recording channel. The image recorded by the image recorder unit 34 is thus always sharp if the corresponding object image on the reticle 28 can likewise be seen to be sharp.

Other typical functions of an image recorder can also be contained in the recording channel 24, such as an exposure time measurement unit.

The image recording device 10 according to the invention thus enables a user to record images imaged by the objective of the observation device 11. The object can be further observed through the eyepiece unit 26 during the recording of the object image as electronic image. Focussing the object image observed through the eyepiece unit 26 is accomplished on the eyepiece unit 26.

The eyepiece unit 26 is preferably an interchangeable eyepiece unit which also permits the use of standard interchangeable eyepieces of the observation device 11, for example of a Zeiss spotting scope. Preferably, the holder for the eyepiece unit 26 on the image recording device 10 is designed such that the eyepiece units which are compatible with the observation device 11 and can be used with the latter in any case can also be used in the image recording device 10.

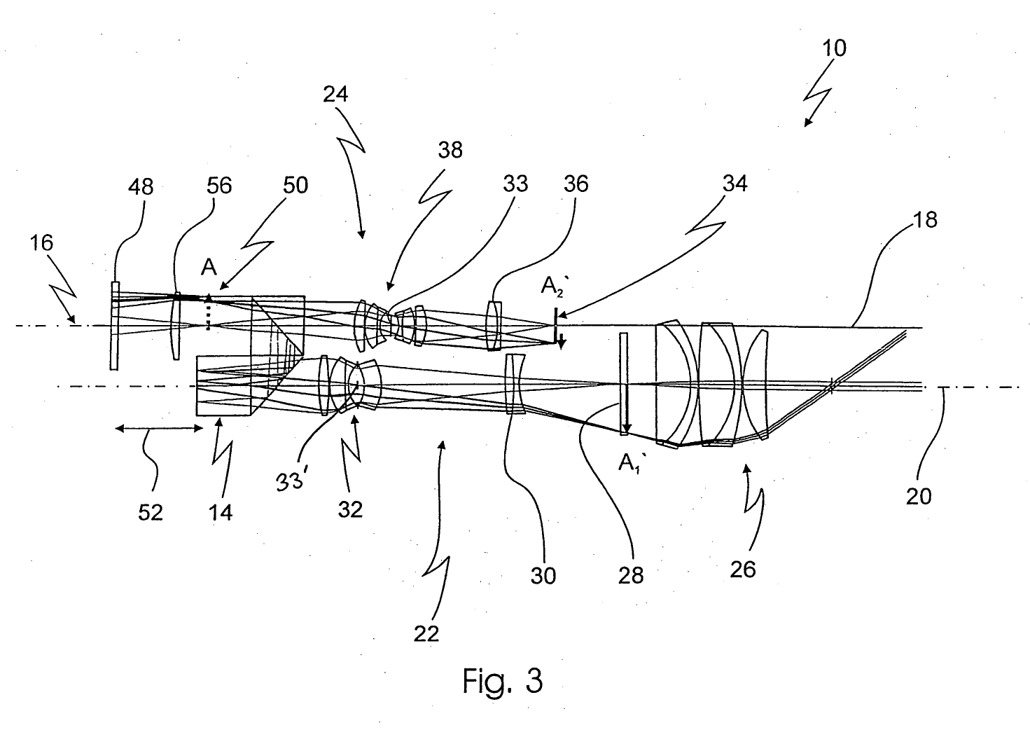

In FIG. 3, a beam path in the observation channel 22 and in the recording channel 24 is illustrated schematically. On the left-hand side of the figure, an end plate 48 representing an input opening for the image recording device 10 is illustrated. The input opening is arranged in the region of the connection unit 12.

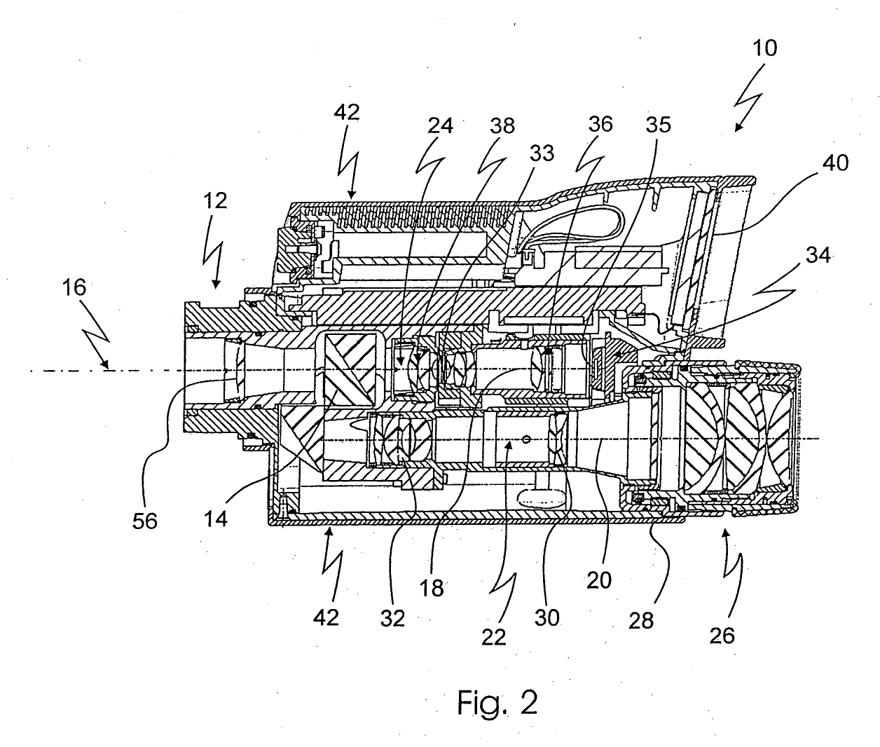

Identical features in FIG. 2 and 3 are provided with identical reference numerals.

In the exemplary embodiment shown, the first optical axis 18 extends the optical axis 16 of the observation device 11 into the image recording device 10. The optical axis 18 is the optical axis 18 of the recording channel 24 in this exemplary embodiment. The beam splitter 14, which, according to FIG. 2 and 3, is in the form of a splitter prism, is arranged on the optical axis 18 and splits the light beam which is incident on the beam splitter 14 into a first light beam propagating in the observation channel 22 and into a second light beam propagating in the recording channel 24. The lens units 30 and 32, the reticle 28 and the eyepiece unit 26 are arranged in the observation channel 22. The first lens unit 38, the second lens unit 36 and the image recorder unit 34 are arranged in the recording channel 24.

A virtual intermediate image 50 (designated as A here) of an object to be observed, produced by the objective of the observation device 11, is located on the input side of the beam splitter 14. The intermediate image 50 is produced by means of a lens 56. The intermediate image 50 is a virtual erect image.

The lens units 30 and 32 of the observation channel 22 image this intermediate image 50 onto the reticle 28 and produce the image designated as A₁′ there.

The lens units 36 and 38 of the recording channel 24 image the intermediate image 50 on the image recorder unit 34 as image A₂′.

The image A₁′ can have a different magnification than the image A₂′. The image A₂′ is typically smaller than the image A₁′.

A distance from the intermediate image 50 to the end plate 48 is, for example, about 26 mm.

What is claimed is:

1. An image recording device for eyepiece-side connection to an observation device providing an object image of an object to be observed, comprising
an image recorder unit for recording the object image,
an eyepiece unit, and
a beam splitter for splitting an incoming light beam into a first light beam directed towards said image recorder unit and a second light beam directed towards said eyepiece unit for observing said object image through said eyepiece unit.

2. The image recording device of claim 1, wherein a reticle is arranged between said beam splitter and said eyepiece unit such that a position of said reticle and a position of said image recorder unit are conjugate to one another.

3. The image recording device of claim 2, wherein at least one lens unit is arranged between said beam splitter and said reticle.

4. The image recording device of claim 1, wherein at least one diaphragm is provided between said beam splitter and said eyepiece unit.

5. The image recording device of claim 1, wherein said eyepiece unit has a focussing device for manually focussing said object image observed through said eyepiece unit.

6. The image recording device of claim 1, wherein said image recorder unit has a photosensitive element.

7. The image recording device of claim 6, wherein said photosensitive element is an electronic imager.

8. The image recording device of claim 1, wherein at least one lens unit is provided between said beam splitter and said image recorder unit.

9. The image recording device of claim 1, wherein at least one diaphragm is arranged between said beam splitter and said image recorder unit.

10. The image recording device of claim 1, further comprising a connection unit for connection to said observation device.

11. The image recording device of claim 1, wherein said eyepiece unit is interchangeable.

12. An observation device which provides an object image of an object to be observed, comprising an image recording device for recording said object image, said image recording device comprising
an image recorder unit for recording the object image,
an eyepiece unit, and
a beam splitter for splitting an incoming light beam into a first light beam directed towards said image recorder unit and a second light beam directed towards said eyepiece unit for observing said object image through the eyepiece unit.

13. The observation device of claim 12, wherein a reticle is arranged between said beam splitter and said eyepiece unit such that a position of said reticle and a position of said image recorder unit are conjugate to one another.

14. The observation device of claim 13, wherein at least one lens unit is arranged between said beam splitter and said reticle.

15. The observation device of claim 12, wherein at least one diaphragm is provided between said beam splitter and said eyepiece unit.

16. The observation device of claim 12, wherein said eyepiece unit has a focussing device for manually focussing said object image observed through said eyepiece unit.

17. The observation device of claim 12, wherein said image recorder unit has a photosensitive element.

18. The observation device of claim 17, wherein said photosensitive element is an electronic imager.

19. The observation device of claim 12, wherein at least one lens unit is provided between said beam splitter and said image recorder unit.

20. The observation device of claim 12, wherein at least one diaphragm is arranged between said beam splitter and said image recorder unit.

21. The observation device of claim 12, further comprising a connection unit for connection to said observation device.

22. The observation device of claim 12, wherein said eyepiece unit is interchangeable.
